(19) United States
(12) Patent Application Publication
(10) Pub. No.: US 2015/0161544 A1
(43) Pub. Date: Jun. 11, 2015

(54) Procurement Demand Capturing

(71) Applicant: International Business Machines Corporation, Armonk, NY (US)

(72) Inventors: Piero Giangrasso, Wappingers Falls, NY (US); Gautam Majumdar, Wappingers Falls, NY (US); Susan Pichini, Fishkill, NY (US); Hans-Peter Purchess, Grossbeeren (DE)

(73) Assignee: International Business Machines Corporation, Armonk, NY (US)

(21) Appl. No.: 14/098,577

(22) Filed: Dec. 6, 2013

(51) Int. Cl. G06Q 10/06

(52) U.S. Cl. CPC G06Q 10/06315

(57) ABSTRACT

Dynamic routing of a procurement request from a single point of entry to a downstream repository is provided based on intelligence data analytics at the point of entry. The point of entry functions as a front end to receive, process, and route all procurement requests, with the back end to support the routed request. Request information is entered at the front end, with the single point of entry processing the request through appropriate channels in the procurement process.

### BACKGROUND

### Technical Field

The present invention relates to efficiently and effectively processing a procurement request. More specifically, the invention relates to establishment of a single point of entry for the request in a procurement process together with dynamic routing of the request.

Procurement is the acquisition of goods or services from an external source. The process of procurement is often part of a business entity's strategy because of the ability to purchase and the timely availability of certain materials will determine if operations will continue. A business entity will be challenged to survive if the cost of procurement is greater than the profit from selling the goods or services. The procurement process may vary among business entities, but in general can be challenging to navigate and frequently delays in the process occur. Any such delays may impact various aspects of the business entity, including but not limited to, client proposal and fulfillment processes, and customer satisfaction.

### SUMMARY OF THE INVENTION

This invention comprises a method, system, and computer program product for submission and routing of a request in a procurement process.

A method, computer program product, and article are provided for facilitating submission and processing of a request in the form of a business artifact through a procurement process. The request is captured, including solicitation of a topic of the request, and the request is transformed into a new business artifact. This new business artifact is employed as a factor for searching two or more repositories downstream from a point of entry into the procurement system. Results of the search are indicative of a direction for routing. The new artifact is dynamically routed to a downstream repository. The routing of the new artifact includes mapping the request to an appropriate downstream location so that the request flows through an appropriate channel in the procurement process from the point of entry.

Other features and advantages of this invention will become apparent from the following detailed description of the presently preferred embodiment of the invention, taken in conjunction with the accompanying drawings.

### BRIEF DESCRIPTION OF THE DRAWINGS

The drawings referenced herein form a part of the specification. Features shown in the drawings are meant as illustrative of only some embodiments of the invention, and not of all embodiments of the invention unless otherwise explicitly indicated. Implications to the contrary are otherwise not to be made.

FIG. 1 is a block diagram depicting a single point entry system associated with the procurement process.

FIG. 2 is a flow chart depicting the procurement process embodied in the block diagram of FIG. 1.

FIG. 3 is a block diagram depicting a system for capturing and process one or more requests for procurement.

FIG. 4 is a block diagram showing a system for implementing an embodiment of the present invention.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional unit described in this specification has been labeled with tools, modules, and/or managers. The functional unit may be implemented in programmable hardware devices such as field programmable gate arrays, programmable array logic, programmable logic devices, or the like. The functional unit may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of an identified functional unit need not be physically located together, but may comprise disparate instructions stored in different locations which, when joined logically together, comprise the functional unit and achieve the stated purpose of the functional unit.

Indeed, a functional unit of executable code could be a single instruction, or many instructions, and may even be distributed over several different code segments, among different applications, and across several memory devices. Similarly, operational data may be identified and illustrated herein within the functional unit, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of managers, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

In the following description of the embodiments, reference is made to the accompanying drawings that form a part hereof, and which shows by way of illustration the specific embodiment in which the invention may be practiced. It is to be understood that other embodiments may be utilized because structural changes may be made without departing from the scope of the present invention.

A single point of entry into the procurement process is provided for procurement processing. Received request are processed at the entry point and routed to a procurement path or contact. In one embodiment, the request may require sourcing, such as a request for quote or a request for proposal, in which case the request is routed to a sourcing representative. The single point of entry provides an efficient connection between the submitted request and an appropriate channel within the procurement process.

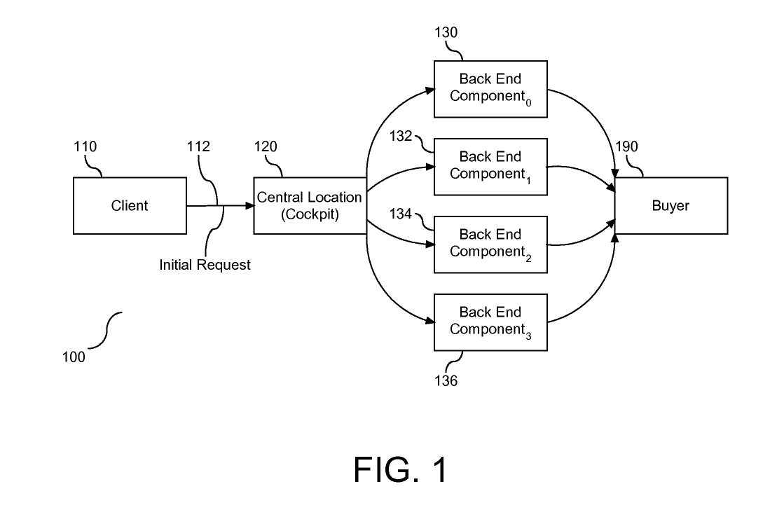

FIG. 1 is a block diagram (100) depicting the single point entry system associated with the procurement process. As shown, the procurement process includes a client (110) and a buyer (190). The client (110) is the entity who is responsible for submission of a request for procurement. As shown, the initial request (112) originates with the client (110) and is received at a central location (120) within the process. In one embodiment, the central location (120) is referred to as a procurement cockpit. The arrows in the diagram demonstrate the flow of information. As shown, the central location only receives input from a client (110). In one embodiment, there may be two or more clients each which may individually submit requests for procurement sourcing to the central location (120). Accordingly, the procurement cockpit (120) functions as a front end to the procurement process to receive all procurement submissions.

Internal aspects of the procurement process, also referred to herein as the back end, are shown in communication with the cockpit (120). More specifically, each back end component is in a uni-directional relationship with the cockpit (120), wherein the back end components function as recipients of communications from the cockpit (120). In the example shown herein, there are four back end elements (130), (132), (134), and (136) in communication with the cockpit (120). The request is processed at the cockpit (120) and routed to one of the back end elements (130)-(136). Processing of the request includes capturing requirements in support of the request and collaborating with the party that submitted the request to the cockpit. Different aspects of procurement have different requirements. The cockpit not only receives the procurement request, but also processes the request to ensure that the request meets the requirements. In one embodiment, the cockpit sends key data elements to an appropriate downstream location while transforming procurement data into new business artifacts. As shown, each back end element (130)-(136) has a uni-directional relationship with the cockpit (120), wherein all communications originate with the cockpit (120). Accordingly, the cockpit (120) captures all receive requests and through processing matches the request with a downstream entity.

As shown in FIG. 1, a request is received and processed by the cockpit. In one embodiment, answers are solicited to a set of questions, with the answers describing the request. This enables the request to be routed along a proper procurement path and contact. The arrows indicate the direction of the request processing through the procurement process. In one embodiment, the request is communicated either directly or indirectly to a buyer. For example, in the case of a contract award, the request may be forwarded directly to the buyer, after which direct communications between the buyer and the requester are enabled.

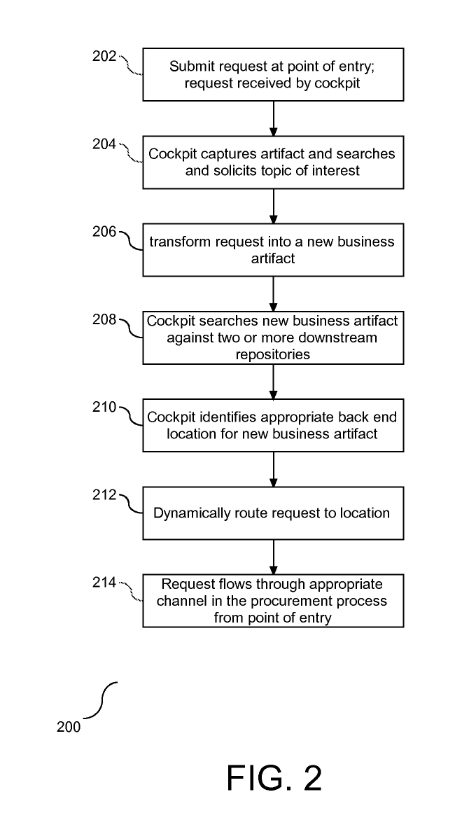

FIG. 2 is a flow chart (200) depicting the procurement process embodied in the block diagram of FIG. 1. As shown in FIG. 1, one or more clients are in communication with the cockpit, which functions as a recipient for procurement at the gateway. For purposes of illustration, one client is described herein for submission of a procurement request. The client is referred to as a point of entry, and the request is submitted at the point of entry and received by the cockpit (202). The request is also referred to herein as an originating business artifact. The cockpit receives and captures the artifact, and matches the artifact with a back end entity for servicing the request. The originating request is captured by the cockpit (204), with the capturing including searching the request and soliciting a topic of the request. In one embodiment, a set of questions are presented to the client upon presentation of the request, with the questions soliciting a description of the request. More specifically, the questions solicit keywords and comments, with the keywords and comments employed as a basis to direct the submission to an accurate and/or appropriate back end location. Based on the request capture and processing, the request is transformed into a new business artifact (206). More specifically, the new business artifact is associated with a specific aspect of the procurement. In one embodiment, the new business artifact may be in the form of a request for proposal or a supplier contract. Accordingly, the cockpit functions as a gateway for all incoming communications to the procurement process, and also functions for directing the process communication(s) to an appropriate back end location.

Following receipt of the incoming request together with responses to solicitation, such as keyword(s), comment(s), and/or phrase(s), the cockpit searches the new business artifact against two or more downstream repositories (208). The responses to the solicitation function to connect the request with an accurate back end repository. Based on the search, the cockpit identifies the appropriate back end location for the new business artifact (210) and dynamically routes the request to that location (212). The dynamic routing maps the request to the location and the request flows through an appropriate channel in the procurement process from the point of entry (214). One focus of the cockpit is the single point of entry, and another focus is proper directing of the received request. In one embodiment, the cockpit routes the processed request to a specific service provider within the procurement process.

The request received by the cockpit may flow through two or more back end locations through the procurement process. The cockpit is responsible for receiving the request and directing the request to a first location in the back end. In one embodiment, a dashboard display is provided to facilitate visibility, e.g. online visibility, and tracking of the request through the procurement process. For example, the request may be forwarded from the cockpit to a first back end location, and following processing at the first location, the request is then forward to a subsequent back end location, which may or may not be a final backend location. Each time the request is serviced, the status and location of the request is updated on the dashboard display (216). More specifically, the dashboard display functions as a venue to provided visibility to the requester of the status of the request within the procurement process. Accordingly, the cockpit is a single centralized tool to enable efficient and accurate processing of business artifacts associated with the procurement process.

As will be appreciated by one skilled in the art, aspects of the present invention may be embodied as a system, method or computer program product. Accordingly, aspects of the present invention may take the form of an entirely hardware based embodiment, an entirely software based embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

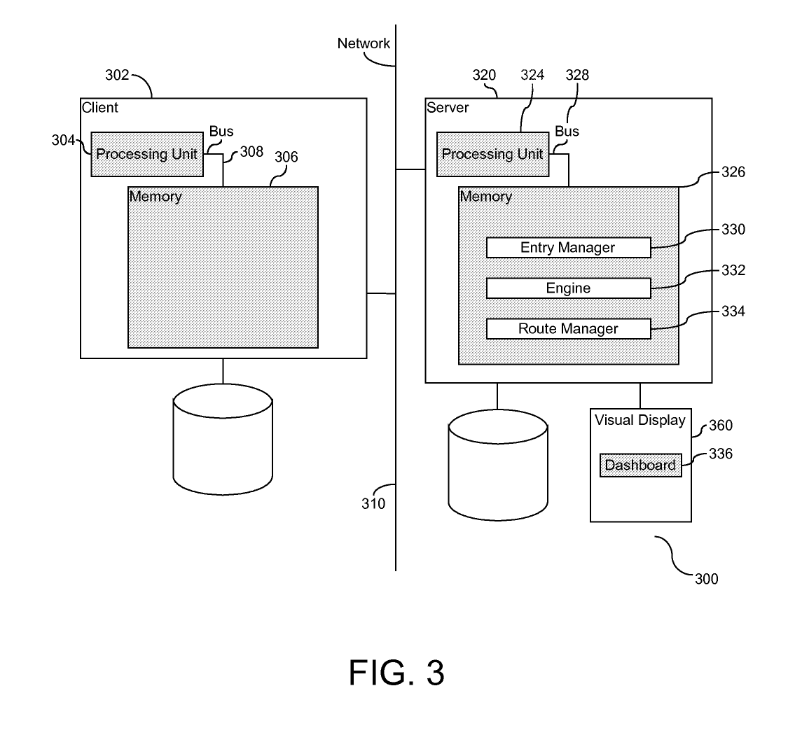

FIG. 3 is a block diagram (300) depicting a system for capturing and process one or more requests for procurement. A client machine (302) is provided in communication with a sever (320) across a network connection (310). While only a single client machine (302) is shown, it is understood that more than one client machine may be in communication with the server (320). The client machine is provided with a processing unit (304) in communication with memory (306) across a bus (308). Similarly, the server (320) is provided with a processing unit (324) in communication with memory (326) across a bus (328). The processing unit (324) functions to perform the processes to support dynamic routing of a business artifact to a procurement representative. More specifically, a set of tools is provided in communication with memory (326). The tools include, but are not limited to, an entry manager (330), an engine (332), and a route manager (334). As noted above, there is a single point of entry into the procurement system. The entry manager (330) functions as the point of entry into the procurement system, and more specifically, the entry manager (330) receives procurement requests. In one embodiment, the received request is a business artifact. In one embodiment, the business artifact is associated with an aspect of the procurement, including but not limited to, a request for proposal or a supplier contract. The entry manager (330) captures each received request and searches the request to solicit a topic associated with the request. Specifically, the solicitation of the topic as facilitated by the entry manager (330) includes distinguishing one or more keywords from the request and using the captured keyword(s) as a basis to route the request to a downstream location within the procurement process. Accordingly, the entry manager (330) functions in conjunction with the point of entry to the procurement system to facilitate and handle procurement requests.

The engine (332) is in communication with the entry manager (330) and functions to transform each captured request into a new business artifact. More specifically, the engine searches the new business artifact against at least two repositories downstream from the point of entry (340) to assess an appropriate downstream repository for the request. In one embodiment, the downstream repository is a specific service associated with the procurement request. The route manager (334) functions with the engine (332), and dynamically routes the request to the appropriate downstream repository. As part of the dynamic routing, the route manager (334) maps the request to the downstream repository. Accordingly, the engine (332) in conjunction with the route manager (334) functions to process the request so that it flows from the point of entry through an appropriate channel in the procurement process.

A dashboard display (336) is provided in communication with the client machine (302). The dashboard display provides visibility of the request as it flows through the procurement process. More specifically, the dashboard display (336) is in communication with the route manager (334), so that the dashboard display may process and convey status updates regarding the request. In one embodiment, a visual display (360) is provided in communication with the client machine (302), and data tracked by the dashboard display (336) is presented on the visual display (360). Accordingly, the status of the request may be tracked and updated through the procurement process.

As identified above, the entry manager (330), engine (332), route manager (334) and dashboard display (336), hereinafter referred to as tools, function as elements to support dynamic routing of one or more requests through a procurement process. The tools (330)-(336) are shown residing in memory (306) local to the computing device (302). However, the tools (330)-(336) may reside as hardware tools external to memory (306), or they may be implemented as a combination of hardware and software. Similarly, in one embodiment, the tools (330)-(336) may be combined into a single functional item that incorporates the functionality of the separate items. As shown herein, each of the tools (330)-(336) are shown local to the computing device (302). However, in one embodiment they may be collectively or individually distributed across a network or multiple machines and function as a unit to dynamically assess and process a procurement request. Accordingly, the tools may be implemented as software tools, hardware tools, or a combination of software and hardware tools.

As will be appreciated by one skilled in the art, aspects of the present invention may be embodied as a system, method or computer program product. Accordingly, aspects of the present invention may take the form of an entirely hardware based embodiment, an entirely software based embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

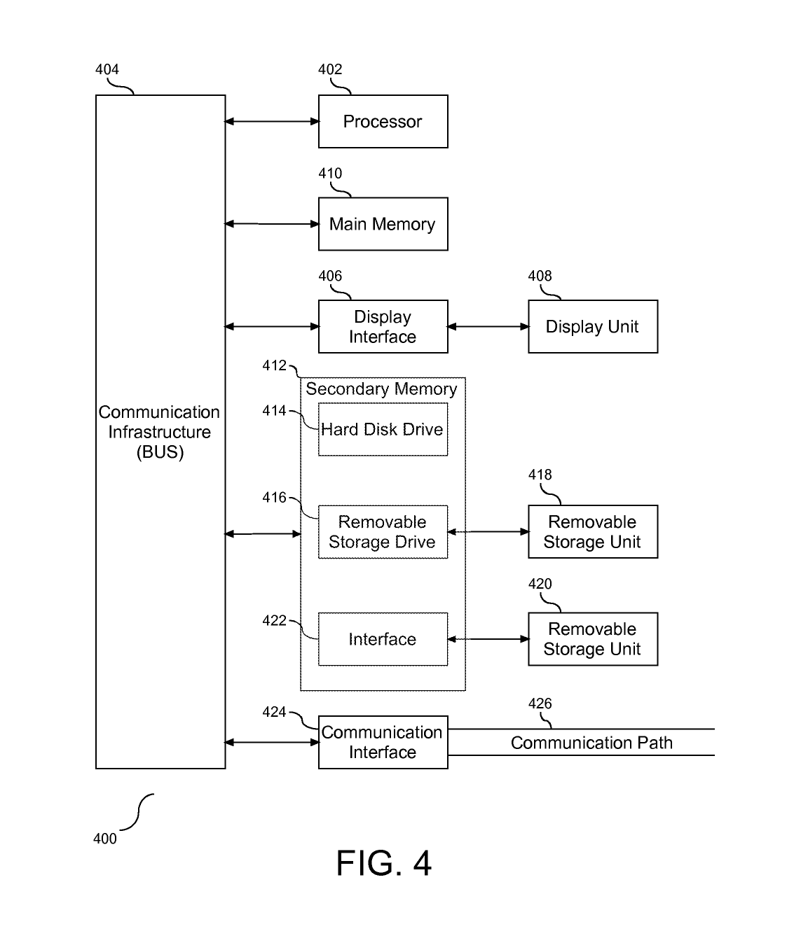

Referring now to the block diagram (400) of FIG. 4, additional details are now described with respect to implementing an embodiment of the present invention. The computer system includes one or more processors, such as a processor (402). The processor (402) is connected to a communication infrastructure (404) (e.g., a communications bus, cross-over bar, or network).

The computer system can include a display interface (406) that forwards graphics, text, and other data from the communication infrastructure (404) (or from a frame buffer not shown) for display on a display unit (408). The computer system also includes a main memory (410), preferably random access memory (RAM), and may also include a secondary memory (412). The secondary memory (412) may include, for example, a hard disk drive (414) (or alternative persistent storage device) and/or a removable storage drive (416), representing, for example, a floppy disk drive, a magnetic tape drive, or an optical disk drive. The removable storage drive (416) reads from and/or writes to a removable storage unit (418) in a manner well known to those having ordinary skill in the art. Removable storage unit (418) represents, for example, a floppy disk, a compact disc, a magnetic tape, or an optical disk, etc., which is read by and written to by a removable storage drive (416). As will be appreciated, the removable storage unit (418) includes a computer readable medium having stored therein computer software and/or data.

In alternative embodiments, the secondary memory (412) may include other similar means for allowing computer programs or other instructions to be loaded into the computer system. Such means may include, for example, a removable storage unit (420) and an interface (422). Examples of such means may include a program package and package interface (such as that found in video game devices), a removable memory chip (such as an EPROM, or PROM) and associated socket, and other removable storage units (420) and interfaces (422) which allow software and data to be transferred from the removable storage unit (420) to the computer system.

The computer system may also include a communications interface (424). Communications interface (424) allows software and data to be transferred between the computer system and external devices. Examples of communications interface (424) may include a modem, a network interface (such as an Ethernet card), a communications port, or a PCMCIA slot and card, etc. Software and data transferred via communications interface (424) are in the form of signals which may be, for example, electronic, electromagnetic, optical, or other signals capable of being received by communications interface (424). These signals are provided to communications interface (424) via a communications path (i.e., channel) (426). This communications path (426) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (410) and secondary memory (412), removable storage drive (416), and a hard disk installed in hard disk drive or alternative persistent storage device (414).

Computer programs (also called computer control logic) are stored in main memory (410) and/or secondary memory (412). Computer programs may also be received via a communication interface (424). Such computer programs, when run, enable the computer system to perform the features of the present invention as discussed herein. In particular, the computer programs, when run, enable the processor (402) to perform the features of the computer system. Accordingly, such computer programs represent controllers of the computer system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed.

Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

### Alternative Embodiment

It will be appreciated that, although specific embodiments of the invention have been described herein for purposes of illustration, various modifications may be made without departing from the spirit and scope of the invention. In one embodiment, collaboration between internal clients of the procurement process takes place to support the needs of the internal client and efficient and effective request processing. Accordingly, the scope of protection of this invention is limited only by the following claims and their equivalents.

We claim:

1. A method comprising:
submitting a procurement based request to a single point of entry in the procurement process, wherein the request is a business artifact;
capturing the request and searching the captured request, including soliciting a topic of the request;
transforming the captured request into a new business artifact;
searching the new business artifact against two or more repositories downstream from the point of entry; and
dynamically routing the request to an appropriate downstream location associated with the new artifact, including mapping the request to the downstream location, wherein the request flows through an appropriate channel in the procurement process from the point of entry.

2. The method of claim 1, further comprising displaying a dashboard for enabling visibility and tracking of the request through the procurement process, wherein the visibility includes a status of the request within the procurement process.

3. The method of claim 1, wherein the routing of the request to a downstream location includes routing the request to a specific service provider associated with the procurement request.

4. The method of claim 1, wherein the soliciting of the topic includes distinguishing one or more keywords from the captured request and using the one or more keywords as a basis for routing the request to the downstream location.

5. The method of claim 1, wherein the business artifact is associated with an aspect of the procurement.

6. The method of claim 5, wherein the business artifact is selected from the group consisting of: a request for proposal and a supplier contract.

7. A computer program product to support dynamic routing of a business artifact to a procurement representative, the computer program product comprising a computer-readable storage device having computer readable program code embodied therewith, the program code executable by a processor to:
receive a procurement based request at a single point of entry in the procurement process, wherein the request is a business artifact;
capture and search the request, including solicitation of a topic of the request;
transform the captured request into a new business artifact;
search the new business artifact against two or more repositories downstream from the point of entry; and
dynamically route the request to an appropriate downstream location associated with the new artifact, including mapping the request to the downstream location, wherein the request flows through an appropriate channel in the procurement process from the point of entry.

8. The computer program product of claim 7, further comprising program code to track the request through the procurement process.

9. The computer program product of claim 8, further comprising program code to enable visibility of the tracked request through the procurement process, wherein the visibility includes a status of the request within the procurement process.

10. The computer program product of claim 7, wherein the route of the request to a downstream location includes receipt of the request by a specific service provider associated with the procurement request.

11. The computer program product of claim 7, wherein the program code to solicit the topic includes distinguishing one or more keywords from the captured request and using the one or more keywords as a basis to route the request to the downstream location.

12. The computer program code of claim 7, wherein the business artifact is associated with an aspect of the procurement.

13. The computer program code of claim 12, wherein the business artifact is selected from the group consisting of: a request for proposal and a supplier contract.

14. A system comprising:
a processing unit in communication with memory;
one or more tools in communication with the memory, the tools to dynamically route of a business artifact to a procurement representative, the tools comprising:
an entry manager in communication with a single point of entry in an associated procurements system, the entry manager to receive a procurement request, wherein the received request is a business artifact;
the entry manager to capture the request and search the captured request, the search including solicitation of a topic of the request;
the entry manager to transform the captured request into a new business artifact;
an engine in communication with the entry manager, the engine to search the new business artifact against two or more repositories downstream from the point of entry; and
a route manager to dynamically route the request to an appropriate downstream location associated with the new artifact, including mapping the request to the downstream location, wherein the request flows through an appropriate channel in the procurement process from the point of entry.

15. The system of claim 14, further comprising a dashboard display in communication with the route manager, the dashboard display to enable visibility and tracking of the request through the procurement process, wherein the visibility includes a status of the request within the procurement process.

16. The system of claim 14, wherein the downstream location includes a specific service provider associated with the procurement request.

17. The system of claim 14, wherein the solicitation of the topic includes distinguishing one or more keywords from the captured request and using the one or more keywords as a basis to route the request to the downstream location.

18. The system of claim 14, wherein the business artifact is associated with an aspect of the procurement.

19. The system of claim 18, wherein the business artifact is selected from the group consisting of: a request for proposal and a supplier contract.
